(19) United States
(12) Patent Application Publication
(10) Pub. No.: US 2018/0033200 A1
(43) Pub. Date: Feb. 1, 2018

(54) SYSTEM AND METHOD FOR MULTIPLE DEVICE AUGMENTED SURFACE

(71) Applicant: Dell Products, LP, Round Rock, TX (US)

(72) Inventors: Mark R. Ligameri, Santa Rosa, FL (US); Michiel Knoppert, Amsterdam (NL); Deeder M. Aurongzeb, Austin, TX (US)

(73) Assignee: Dell Products, LP, Round Rock, TX (US)

(21) Appl. No.: 15/220,106

(22) Filed: Jul. 26, 2016

(51) Int. Cl. G06T 19/00; G02B 27/01; G06F 3/0481; G06F 3/01; H04N 13/02; G06F 3/00

(52) U.S. Cl. CPC G06T 19/006; H04N 13/0203; G06F 3/005; H04N 13/0271; G06F 3/04815; G06F 3/013; G02B 27/0172; G02B 27/0179; G02B 2027/0138; G02B 2027/014

(57) ABSTRACT

An information handling system operating to allow a head mounted display device to display a head mounted digital image such that a user may simultaneously view the head mounted digital image and the displayed base user interface elements from the base computing device. Either the head mounted computing device or base computing device could have a processor executing code instructions of a multiple device augmented surface management system to determine the edges of the base computing device or a user interface as captured in the image of the base computing device. The information handling system may also receive data allowing it to correlate a base user interface element as displayed on the base computing device with an image of the base user interface element as captured in the three-dimensional image of the base computing device.

### FIELD OF THE DISCLOSURE

The present disclosure generally relates to information handling systems, and more particularly relates to merger of user interfaces for multiple computing devices for an augmented user interface surface.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a depiction of a user wearing a head mounted display device according to an embodiment of the present disclosure;

FIG. 3 is a block diagram illustrating a head mounted display device according to an embodiment of the present disclosure;

FIG. 4 is a depiction of a base user interface according to an embodiment of the present disclosure;

FIG. 5 is a depiction of a three-dimensional image of a base user interface according to an embodiment of the present disclosure;

FIG. 6 is a block diagram illustrating a multiple device augmented surface management system according to an embodiment of the present disclosure;

FIG. 7 is a flow diagram illustrating a method of operating a multiple device augmented surface management system according to an embodiment of the present disclosure;

FIG. 8 is a depiction of a first view of the operation of a multiple device augmented surface management system according to an embodiment of the present disclosure;

FIG. 9 is a depiction of a second view of the operation of a multiple device augmented surface management system according to another embodiment of the present disclosure;

FIG. 10 is a flow diagram illustrating a method of a merged interface rendering with the multiple device augmented surface management system according to an embodiment of the present disclosure; and

FIG. 11 is a flow diagram illustrating a method of merger customization with the multiple device augmented surface management system according to the customized merged user interface definition according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Head mounted display devices, wearable around the user's head and/or eyes and having the capability of reflecting projected images as well as allowing the user to see through it may be used with augmented or virtual reality display systems. A user may see through a head mounted display device to view a base computing device with a separate video display and user interface. A base computing device user interface may display a base user interface element, including but not limited to any type of object, button, tile, program window, softkey or other visual representation of a code object that facilitates interaction between the user and the processor. A base computing device may include but may not be limited to any information handling system displaying images and data as described herein and may include a desktop personal computer, a laptop computer, a tablet computer, or a mobile phone. Viewing the base computing device through the head mounted display device while the head mounted display device also reflects projected images may generate a multiple device augmented user interface surface with the multiple device augmented surface management system described in embodiments herein.

In other aspects, a user may interact with the augmented display of the head mounted display device or the base computing system via an augmented user interface input device. The augmented user interface device may include a finger or hand or other implement within the field of view of a head mounted display device. In some embodiments, the augmented user interface input device may include a stylus or a pen. A plane of operation of the augmented user interface device may be tracked by the multiple device augmented surface management system and be cross referenced with respect to the plane of a base computing device such as a tablet or laptop computer. Further the plane of operation of the augmented user interface device may also be tracked by the multiple device augmented surface management system and be cross referenced with respect to planes of images or icons for the head mounted display device. As described below, this may be accomplished via a three dimensional camera system locating the augmented user interface device. In other aspects, a stylus, pen or other augmented user interface device may be fitted with a three axis sensor or optical sensor to communicate tip location or other related data for the augmented user interface device. For example, such a sensor may be affixed or worn on a finger.

In order to generate a multiple device augmented user interface surface, a multiple device augmented surface management system or method may be in place to reflect the projected images of the head mounted display device in such a way that they do not compromise the user's ability to see and/or manipulate the base computing device. Further, in some embodiments, a multiple device augmented surface management system or method may be used to correlate a base user interface element displayed on the base computing device with the image of that base user interface element, as seen through the head mounted display device, such that manipulation of either the base user interface element or the image of the base user interface element acts to perform the same manipulation on both the base user interface element and the image of the base user interface element. Further, in some embodiments, a multiple device augmented surface management system or method may be used to correlate a base user interface element displayed on the base computing device with a head mounted display user interface element, as seen through the head mounted display device, such that manipulation of either the base user interface element or the head mounted display user interface element acts to perform the same manipulation on both the base user interface element and the head mounted display user interface element. The multiple device augmented surface management system or method may involve generation of three-dimensional maps that provide three-dimensional location data for objects seen through the head mounted display device, including but not limited to, the base computing device, user input devices (such as a keyboard, and a cursor user input device, a mouse, touchpad, or gesture or touch screen input), an augmented user input device (such as a stylus, pen, hand, etc.), and objects not related to any user interface aspects (such as legs, furniture, other individuals, etc.). Such three-dimensional maps may enable the reflection of images through the head mounted display device to not obscure any portion of the base computing device, according to user preferences.

In the present disclosure, a multiple device augmented surface management system is established to generate a multiple device augmented user interface surface. In one example embodiment, the multiple device augmented surface management system may involve reflection of images through the head mounted display device such that those images do not obscure the view of the base computing device in any way. In another embodiment, the multiple device augmented surface management system may involve reflection of images through the head mounted display device such that those images may at least partially obscure the base computing device. In one aspect, the reflection of images through the head mounted display device may be coordinated with the user interface display of the base information handling system. In other aspects, the images reflected through the head mounted display device may be two-dimensional or three-dimensional, and/or the multiple device augmented surface management system may correlate a base user interface element displayed on the base computing device with the image of that base user interface element, as seen through the head mounted display device, such that manipulation of either the base user interface element or the image of the base user interface element acts to perform the same manipulation on both the base user interface element and the image of the base user interface element. In another embodiment, a multiple device augmented surface management system or method may be used to correlate a base user interface element displayed on the base computing device with a head mounted display user interface element, as seen through the head mounted display device, such that manipulation of either the base user interface element or the head mounted display user interface element acts to perform the same manipulation on both the base user interface element and the head mounted display user interface element. In one embodiment, the multiple device augmented surface management system is software code executable on one or more application processors, which may reside at the base computing device, at the head mounted display device, or at one or more remote servers and data base systems. In other embodiments, some or all of the multiple device augmented surface management system may include firmware executed via processors or controller or may be hardcoded as an applied specific integrated circuit (ASIC) or other circuit to execute some or all of the operations described in the disclosure herein.

Examples are set forth below with respect to particular aspects of an information handling system for merging of user interfaces for multiple computing devices to create an augmented user interface surface.

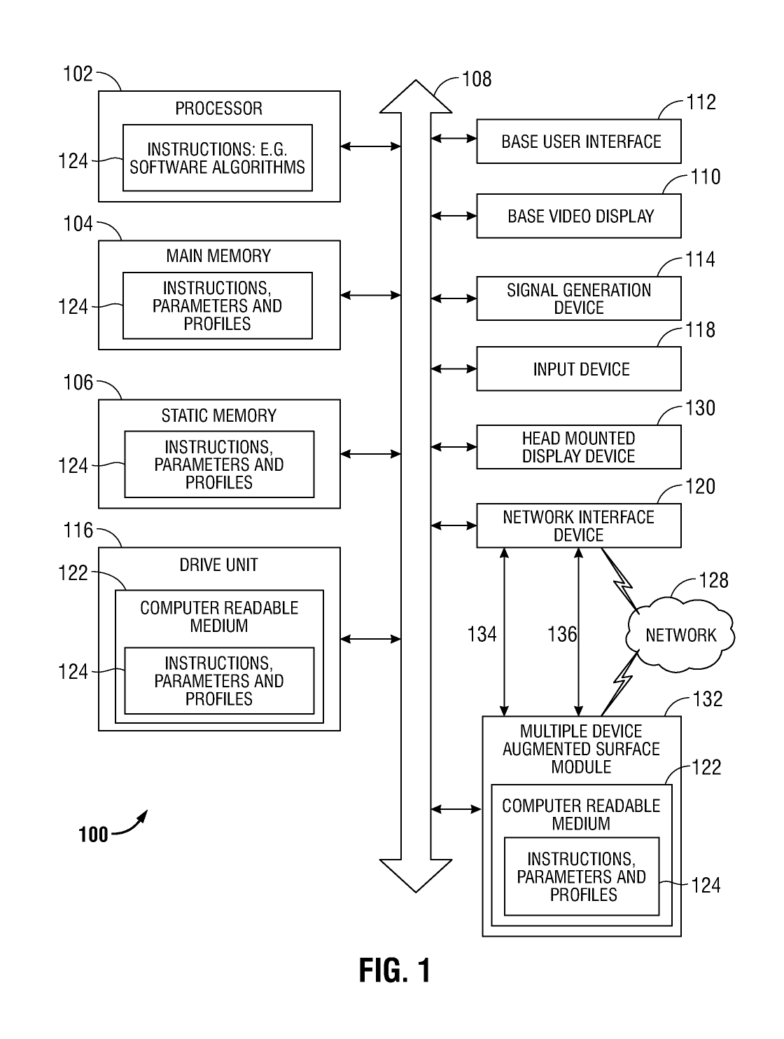

FIG. 1 illustrates a generalized embodiment of information handling system 100. For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device, a head-mounted display device, or other consumer electronic device, a network server, a network storage device, a switch router or other network communication device, or any other suitable device and may vary in size, shape, performance, functionality, and price. Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable media for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

FIG. 1 illustrates an information handling system 100 similar to information handling systems according to several aspects of the present disclosure. For example, an information handling system 100 may be any mobile or other computing device capable of executing a set of instructions (sequential or otherwise) that specify actions to be taken by that machine. In a particular embodiment, the information handling system 100 can be implemented using electronic devices that provide voice, video, or data communication. Further, while a single information handling system 100 is illustrated, the term “system” shall also be taken to include any collection of systems or sub-systems that individually or jointly execute a set, or multiple sets, of instructions to perform one or more computer functions.

Information handling system 100 can include devices or modules that embody one or more of the devices or execute instructions for the one or more systems and modules described above, and operates to perform one or more of the methods described above. The information handling system 100 may execute code 124 for a multiple device augmented surface management system that may operate on servers or systems, remote data centers, or on-box in individual client information handling systems such as a head-mounted display device or a base computing system according to various embodiments herein. In some embodiments, it is understood any or all portions of code 124 for a multiple device augmented surface management system may operate on a plurality of information handling systems 100.

The information handling system 100 may include a processor 102 such as a central processing unit (CPU), a graphics processing unit (GPU), control logic or some combination of the same. Any of the processing resources may operate to execute code that is either firmware or software code. Moreover, the information handling system 100 can include memory such as main memory 104, static memory 106, and drive unit 116 (volatile (e.g. random-access memory, etc.), nonvolatile (read-only memory, flash memory etc.) or any combination thereof). Additional components of the information handling system can include one or more storage devices such as static memory 106 and drive unit 116. The information handling system 100 can also include one or more buses 108 operable to transmit communications between the various hardware components such as any combination of various input and output (I/O) devices. Portions of an information handling system may themselves be considered information handling systems.

As shown, the information handling system 100 may further include a base video display unit 110, such as a liquid crystal display (LCD), an organic light emitting diode (OLED), a flat panel display, a solid state display, or a cathode ray tube (CRT). Additionally, the information handling system 100 may include an input device 118, such as a keyboard, and a cursor user input device, such as a mouse, touchpad, or gesture or touch screen input. The information handling system 100 may also include a head mounted display device 132, which may display images using, for example, a curved mirror based reflection, a waveguide based method or a light guide based method. Waveguide methods may further include, but may not be limited to diffraction optics, holographic optics, polarized optics, and reflective optics. These are just examples, and it is contemplated the head mounted display device may use any method that reflects projected images in order to create an augmented reality.

The information handling system 100 can also include a signal generation device 114, such as a speaker, microphone, ultrasonic speaker, ultrasonic microphone, or remote control. The base video display unit 110 may display a base user interface 112 which incorporates a base user interface element users may manipulate in order to affect communication between the user and the base computing device.

The information handling system 100 can represent a server device whose resources can be shared by multiple client devices, or it can represent an individual client device, such as a desktop personal computer, a laptop computer, a tablet computer, or a mobile phone. In a networked deployment, the information handling system 100 may operate in the capacity of a server or as a client user computer in a server-client user network environment, or as a peer computer system in a peer-to-peer (or distributed) network environment.

The information handling system 100 can include a set of instructions 124 that can be executed to cause the computer system to perform any one or more of the methods or computer based functions disclosed herein. For example, information handling system 100 includes one or more application programs 124, and Basic Input/Output System and Firmware (BIOS/FW) code 124. BIOS/FW code 124 functions to initialize information handling system 100 on power up, to launch an operating system, and to manage input and output interactions between the operating system and the other elements of information handling system 100. In a particular embodiment, BIOS/FW code 124 reside in memory 104, and include machine-executable code that is executed by processor 102 to perform various functions of information handling system 100. In another embodiment (not illustrated), application programs and BIOS/FW code reside in another storage medium of information handling system 100. For example, application programs and BIOS/FW code can reside in static memory 106, drive 116, in a ROM (not illustrated) associated with information handling system 100 or other memory. Other options include application programs and BIOS/FW code sourced from remote locations, for example via a hypervisor or other system, that may be associated with various devices of information handling system 100 partially in memory 104, storage system 106, drive unit 116 or in a storage system (not illustrated) associated with network interface device 120 or any combination thereof. Application programs 124 and BIOS/FW code 124 can each be implemented as single programs, or as separate programs carrying out the various features as described herein. Application program interfaces (APIs) such Win 32 API may enable application programs 124 to interact or integrate operations with one another.

In an example of the present disclosure, instructions 124 may execute the multiple device augmented surface management system 132 as disclosed herein, and an API may enable interaction between the application program and device drivers and other aspects of the information handling system and software instructions 124 thereon. The computer system 100 may operate as a standalone device or may be connected, such as via a network, to other computer systems or peripheral devices.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The disk drive unit 116 may include a computer-readable medium 122 such as a magnetic disk in an example embodiment. The computer-readable medium of the memory, storage devices and a multiple device augmented surface management system 104, 106, 116, and 132 may store one or more sets of instructions 124 such as software code corresponding to the present disclosure.

The disk drive unit 116, and static memory 106, also contains space for data storage such as an information handling system for multiple device augmented surfaces. Data including but not limited to data regarding ambient light measurements, three-dimensional images taken by a three-dimensional camera array, data generated by a user interface regarding coordinates, shape, color, and any other characteristics of appearance of a base user interface element display on said user interface at any given time, data regarding the coordinates, shape, color, resolutions, and any other characteristics of appearance of a video display within which a user interface appears, data regarding identification of base user interface elements identified within user interfaces, characteristics such as position and orientation of base user interface elements displayed within a user interface, data regarding orientation of a video display with respect to a head mounted display device, user input regarding preferred orientation of base user interface elements to be displayed by a head mounted display device, and low-level graphics primitives may also be stored in part or in full in data storage 106 or 116. Further, the instructions 124 may embody one or more of the methods or logic as described herein. For example, instructions relating to the hardware implementation of the head mounted display device 130 or subcomponents, or the multiple device augmented surface management system 132 software algorithms may be stored here.

In a particular embodiment, the instructions, parameters, and profiles 124 may reside completely, or at least partially, within the main memory 104, the static memory 106, disk drive 116 and/or within the processor 102 during execution by the information handling system 100. Software applications may be stored in static memory 106 or disk drive 116.

Network interface device 120 represents a NIC disposed within information handling system 100, on a main circuit board of the information handling system, integrated onto another component such as processor 102, in another suitable location, or a combination thereof. Network interface device 120 includes network channels 134 and 136 that provide interfaces to devices that are external to information handling system 100. In a particular embodiment, network channels 134 and 136 are of a different type than memory bus 108 and network interface device 120 translates information from a format suitable to the memory bus 108 to a format suitable to external devices. An example of network channels 134 and 136 includes InfiniBand channels, Fibre Channel channels, Gigabit Ethernet channels, proprietary channel architectures, or a combination thereof. The network interface device 120 can include another information handling system, a data storage system, another network, a grid management system, another suitable resource, or a combination thereof.

Network channels 134 and 136 can be connected to external network resources, and may be connected directly to a multiple device augmented surface management system 132, or indirectly through network interface device 120 to drive unit 116, both of which can also contain computer readable medium 122. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The information handling system 100 may also include a multiple device augmented surface management system 132 that may be operably connected to the bus 108, may connect to the bus indirectly through the network 128 and the network interface device 120, or may connect directly to the network interface device 120 via the network channels 134 and 136. The multiple device augmented surface management system 132 is discussed in greater detail herein below.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, or module can include software, including firmware embedded at a device, such as a Intel® Core class processor, ARM® brand processors, Qualcomm® Snapdragon processors, or other processors and chipset, or other such device, or software capable of operating a relevant environment of the information handling system. The system, device or module can also include a combination of the foregoing examples of hardware or software. In an example embodiment, the multiple device augmented surface management system 132 above and the several modules described in the present disclosure may be embodied as hardware, software, firmware or some combination of the same. Note that an information handling system can include an integrated circuit or a board-level product having portions thereof that can also be any combination of hardware and software. Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

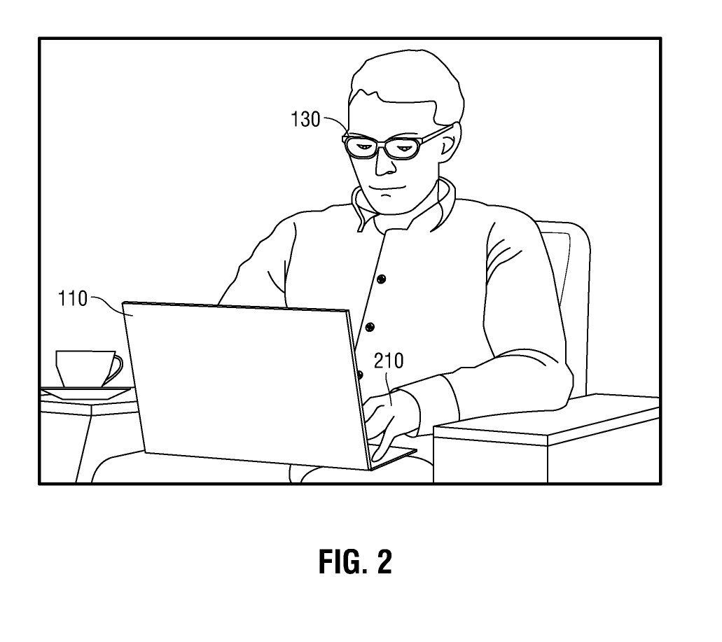

FIG. 2 is a depiction of a user wearing a head mounted display device according to an embodiment of the present disclosure. As shown in FIG. 2, in an embodiment, a user wearing a head mounted display device 130 may look through the head mounted display device 130 to view a base video display 110 and a non-base user interface feature 210. A non-base user interface feature may be any feature captured in a three-dimensional image that is not within the base video display 110, or that is not a graphical user interface. For example, in an embodiment, the non-base user interface feature 210 visible by the head mounted display device 130 may include the user's hand. In some aspects, a non-base user interface feature may function as a user input device to control one or both the user interface of a video display 110 or a user interface of a head-mounted display device 130. In an embodiment, the base video display 110 may include any type of video monitor or group of video monitors operably connected to the information handling system, including, but not limited to, monitors of desktop computers, monitors of tablet computers, monitors of laptop computers, or remote monitors.

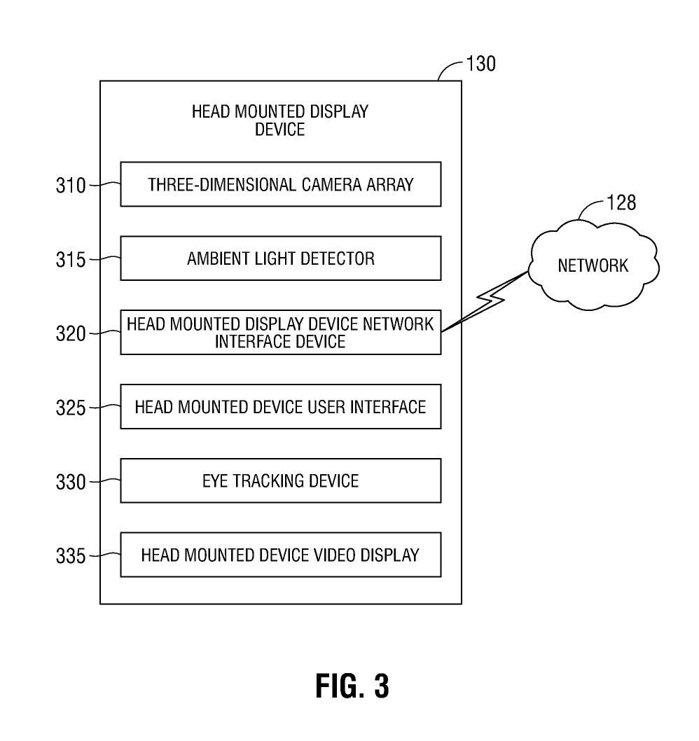

FIG. 3 is a block diagram illustrating a head mounted display device according to an embodiment of the present disclosure. In an embodiment, a head mounted display device may be an information handling system, wearable around the user's head and/or eyes that has the capability of reflecting projected images as well as allowing the user to see through it. A user may see through a head mounted display device to view a base computing device with a separate video display and user interface. As shown in FIG. 3, the head mounted display device 130 may include a three-dimensional camera array 310, an ambient light detector 315, a head mounted display device network interface device 320, a head mounted device user interface 325, an eye tracking device 330, and a head mounted device video display 335. As discussed in the present disclosure, the head mounted display device 130 may be operatively connected to a bus (not shown), or may connect to the bus indirectly by connecting with the network 128 or connecting to the network interface device 320 via network channels (not shown).

In an embodiment, it is understood that the three-dimensional camera array 310, as shown in FIG. 3, may include a three-dimensional (3-D) camera, e.g., a stereo triangulation camera, a sheet of light triangulation camera, a structured light camera, a time-of-flight camera, an interferometry camera, a coded aperture camera, or any other type of 3-D camera. The ambient light detector 315 in an embodiment may be any type of electro-optical sensor capable of detecting ambient light surrounding the head mounted display device 130 and converting the ambient light into an electronic signal, including but not limited to photoconductive devices, photovoltaics, photodiodes, or phototransistors. The head mounted display device 130 in an embodiment can also include a head mounted display device network interface device 320 that may be a wired network adapter or may be a wireless adapter as shown. As a wireless adapter, the head mounted display device network interface device 320 can provide connectivity to the network 128 in an embodiment. A wired network interface connected both directly into the bus and indirectly through network channels and a network interface device are also contemplated (not shown).

As shown in FIG. 3, the head mounted display device 130 in an embodiment may further include a head mounted device user interface 325. The head mounted device user interface 325 in an embodiment may facilitate interactions between the human user and the head mounted display device 130, and/or between the human user and the base user interface. The head mounted device user interface 325 in an embodiment may involve, but may not be limited to graphical, tangible, voice-command, gesture, and virtual control elements. Further, interaction with the head mounted device may be via an augmented user interface device as described above such that a plane of operation of the augmented user interface device may be detected from sensors on the augmented user interface device, from three dimensional cameras or the like and communicated to the multiple device augmented surface management system. Cross referencing that plane of operation with planes established for base computing devices and tiered extension planes for placement of icons or images displayed by the head mounted device provides for interaction with icons or images in the head mounted display device as well a images and icons that may appear or be associated and displayed in the base information handling system.

As shown in FIG. 3, the head mounted display device 130 in an embodiment may further include an eye tracking device 330. The eye tracking device 330 in an embodiment may be capable of measuring a user's eye positions and eye movement as an input for human-computer interaction. The eye tracking device 330 in an embodiment may use any method for measuring eye position, eye movement, the point of gaze, or the motion of a user's eye relative to the user's head, including, but not limited to extracting eye position from video images, and/or the use of search coils, and/or electrooculograms.

As shown in FIG. 3, the head mounted display device 130 in an embodiment may further include a head mounted video display unit 335, which reflects images through the head mounted display device. These reflected images may comprise the head mounted display device user interface 325. The head mounted video display unit 335 may reflect images through the head mounted display device using, for example, a curved mirror based reflection, a waveguide based method or a light guide based method. Waveguide methods may further include, but may not be limited to diffraction optics, holographic optics, polarized optics, and reflective optics. These are only a few examples of potential means of reflecting images through the head mounted display device, and it is contemplated the head mounted display device may use any method that reflects projected images in order to create an augmented reality.

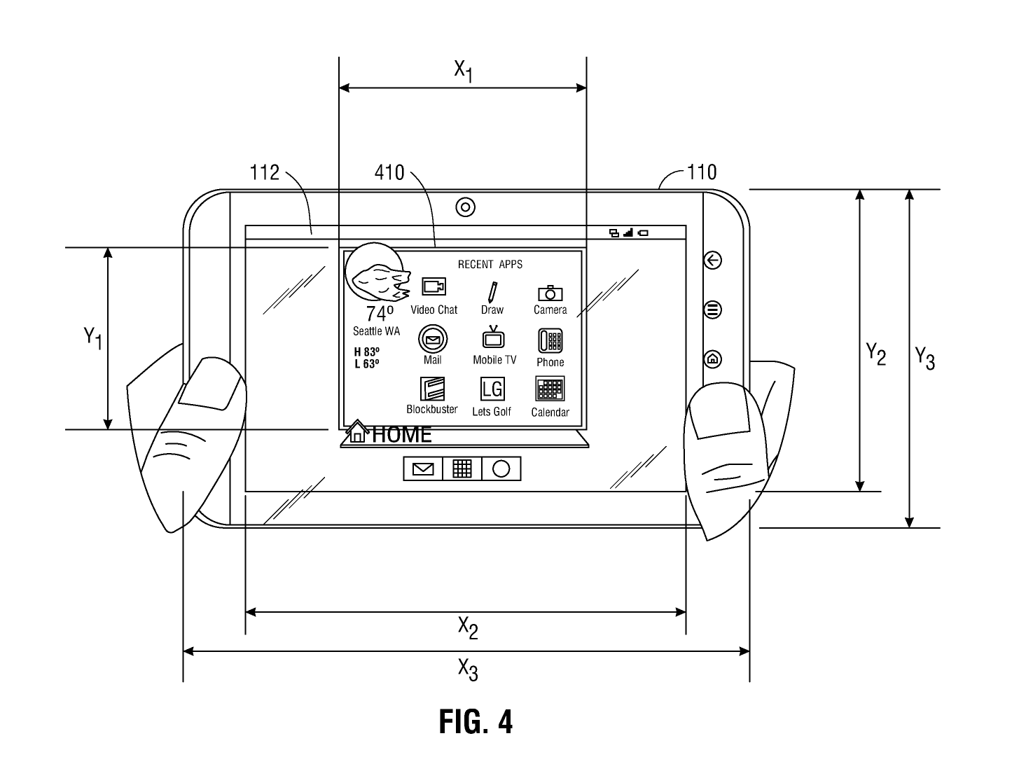

FIG. 4 is a depiction of a base user interface according to an embodiment of the present disclosure. In an embodiment, the base user interface 112 may include a base user interface element 410, which conveys a specific type of information to the user. The base user interface element 410 shown in FIG. 4 within the white-boxed border is a navigation tile for the home page of the user interface 112, however, the base user interface element 410 in an embodiment could be any type of object, button, tile, icon, program window, or other visual representation of a code object that facilitates interaction between the user and the processor. As shown in FIG. 4, the base user interface element 410 in an embodiment may have a width X₁ and height Y₁. As shown in FIG. 4, the base user interface 112 in an embodiment may have a width X₂ and height Y₂. As shown in FIG. 4, the base video display 110 in an embodiment may have width X₃ and height Y₃.

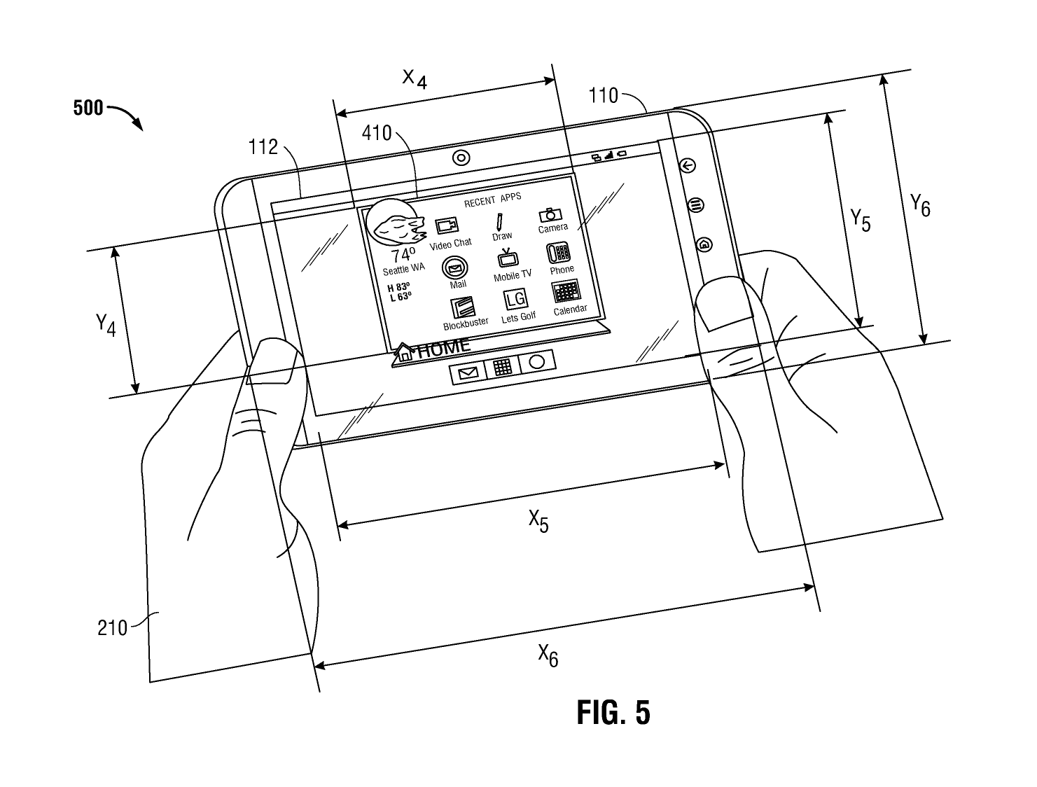

FIG. 5 is a depiction of a three-dimensional image of a base user interface according to an embodiment of the present disclosure. FIG. 5 shows a depiction, in an embodiment, of a three-dimensional image 500 of the base video device 110, base user interface 112, base user interface element 410, and a non-base user interface feature 210. As shown in FIG. 5, the head mounted display device (not shown), and thus the three-dimensional camera array (not shown) in an embodiment may view the base user interface 112 within the base video display 110 at an angle other than perfectly perpendicular from and/or directly above the base user interface 112. As shown in FIG. 5, the head mounted display device in an embodiment may perceive the top of the base user interface 112 as farther away from the head mounted display device 112 than the bottom of the base user interface 112, particularly if a user tilts the base video display 110. Depth may be determined by the three-dimensional camera at portions across the base video display 110. If the user tilts the device in such a way, the dimensions of the base user interface element 410 as viewed by the head mounted display device may appear skewed when compared to the dimensions of the base user interface element 410 as displayed by the base user interface 112.

For example, although the display of the base user interface 112 in an embodiment does not change between FIGS. 4 and 5, the measurement of the width X₁ of the base user interface element 410 in FIG. 4 is not equivalent to the measurement of the width X₄ of the same base user interface element 410 in FIG. 5. This skewed appearance in an embodiment is the result of a difference in orientation of the plane of the base video display 110 and base user interface 112 between FIGS. 4 and 5. As shown in FIG. 5, the base user interface element 410 in an embodiment, as viewed from the head mounted display device may have a width X₄ and height Y₄. As shown in FIG. 5, the base user interface 112 in an embodiment, as viewed from the head mounted display device may have a width X₅ and height Y₅. As shown in FIG. 5, the base video display 110 in an embodiment, as viewed from the head mounted display device may have width X₆ and height Y₆.

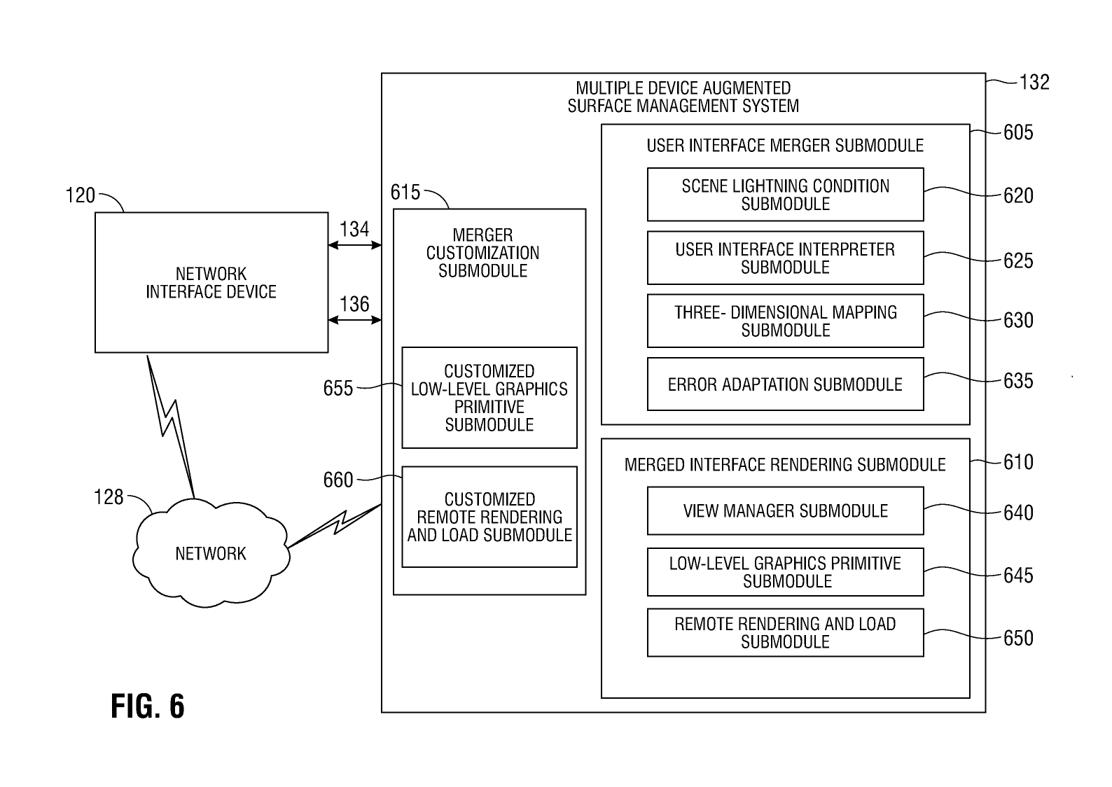

FIG. 6 is a block diagram illustrating a multiple device augmented surface management system according to an embodiment of the present disclosure. The information handling system can include devices or modules that embody the multiple device augmented surface management system 132, and the information handling system may execute code for a multiple device augmented surface management system 132 that may operate on servers or systems, remote data centers, or on-box in individual client information handling systems according to various embodiments herein. In an example of the present disclosure, code instructions may execute the multiple device augmented surface management system 132 as disclosed herein, and an API may enable interaction between the application program and device drivers and other aspects of the information handling system and software instructions thereon. The multiple device augmented surface management system 132 can also be configured as hardware as described above. For example, a portion of the multiple device augmented surface management system 132 may be hardware such as, for example, an integrated circuit (such as an Application Specific Integrated Circuit (ASIC), a Field Programmable Gate Array (FPGA), a structured ASIC, or a device embedded on a larger chip), a card, or a system (such as a motherboard, a system-on-a-chip (SoC), or a stand-alone device). The multiple device augmented surface management system 132 can also have some or all parts to include software, including firmware embedded at a device, capable of operating a relevant environment of the information handling system. The multiple device augmented surface management system 132 can also include a combination of the foregoing examples of hardware or software.

As shown in FIG. 6, the multiple device augmented surface management system 132 may connect to a bus of an information handling system indirectly through the network 128 and the network interface device 120, or may connect directly to the network interface device 120 via the network channels 134 and 136. One example embodiment of an information handling system is described with respect to FIG. 1. The multiple device augmented surface management system 132 may also connect directly to the bus of the information handling system. As shown in FIG. 6, the multiple device augmented surface management system 132 in an embodiment may include a user interface merger submodule 605, a merged interface rendering submodule 610, and a merger customization submodule 615. In an embodiment, the user interface merger submodule 605 may operate to identify features not associated with the base user interface as captured in a three-dimensional image, identify and correlate base user interface elements displayed in the base user interface with base user interface elements captured in the three-dimensional image, and to generate a three-dimensional map of the base user interface, base user interface elements, and non user-interface features, as described in further detail herein. The merged interface rendering submodule 610, in an embodiment, may operate to render a two-dimensional or three-dimensional head mounted display device user interface that does not obscure the user's view of the base video display, such that the base user interface and head mounted display device user interface merge together to form a single augmented user interface surface, as discussed in further detail herein. The merger customization submodule 615, in an embodiment, may operate to receive and store customized merged user interface definitions, and may utilize those customized merged user interface definitions to render a customized merged user interface, as discussed herein in further detail.

Each of these submodules may contain further submodules. For example, the user interface merger submodule 605, in an embodiment, may further contain the scene lighting condition submodule 620, the user interface interpreter submodule 625, the three-dimensional mapping submodule 630, and the error adaptation submodule 635. The scene lighting condition submodule 620, in an embodiment, may operate to measure ambient light surrounding the head mounted display device, and adjust the contrast of the three-dimensional image based on that ambient light measurement. The user interface interpreter submodule 625 may operate to identify and correlate a base user interface element displayed within the base user interface with a base user interface element captured in the three-dimensional image taken by the three-dimensional camera array on the head mounted display device, to determine the orientation of the base video display plane with respect to the head mounted display device, and to identify a non-base user interface feature in the three-dimensional image. The three-dimensional mapping submodule 630, in an embodiment, may operate to identify the borders of the base video display in the three-dimensional image and to generate a three-dimensional map of the base video display, base user interface, base user interface element, and non-base user interface feature. The error adaptation submodule 635 in an embodiment, may operate to detect errors in feature identification and mapping, and correct those errors as necessary.

The merged interface rendering submodule 610, in an embodiment, may further contain the view manager submodule 640, the low-level graphics primitives submodule 645, and the remote rendering and load submodule 650. The view manager submodule 640, in an embodiment, may operate to prompt user input regarding the way in which the user chooses to merge the base user interface and the head mounted display device user interface together to form a single augmented user interface surface. The low-level graphics primitives submodule 645 may operate to generate and place within the three-dimensional map generated by the three-dimensional mapping submodule 630 graphics primitives of the head mounted display device user interface elements. These graphics primitives may be placed in the three-dimensional map in multiple orientations, including, but not limited to: (1) solely outside the borders of the base video display; and (2) within and/or outside the borders of the base video display. The remote rendering and load submodule 650, in an embodiment, may operate to render the head mounted display device user interface elements upon the low-level primitives which may be oriented in one of many different ways, including, but not limited to: (1) solely outside the borders of the base video display; and (2) within and/or outside the borders of the base video display.

The merger customization submodule 615, in an embodiment, may further contain the customized low-level graphics primitives submodule 655 and the customized remote rendering and load submodule 660. The customized low-level graphics primitives submodule 655 may operate to generate and place within the three-dimensional map generated by the three-dimensional mapping submodule 630 graphics primitives of the head mounted display device user interface elements, according to customized merged head mounted display device user interface element definitions received by the merger customization submodule 615. The customized remote rendering and load submodule 660, in an embodiment, may operate to render the head mounted display device user interface elements according to customized merged head mounted display device user interface element definitions received by the merger customization submodule 615.

In an example of the present disclosure, code instructions may execute the multiple device augmented surface management system 132 as disclosed herein, and an API may enable interaction between the application program and device drivers and other aspects of the information handling system and software instructions thereon. In an embodiment, the scene lighting condition submodule 620 may be capable of accessing data including but not limited to ambient light measurements captured by the ambient light detector and the three-dimensional image generated by the three-dimensional camera array. In an embodiment, the user interface interpreter submodule 625 may be capable of accessing data including but not limited to data generated by the base user interface regarding the coordinates, shape, color, and any other characteristics of appearance of each base user interface element as displayed on the user interface at any given time. For example, with respect to the embodiment described in FIG. 4, the user interface interpreter submodule may have access to data generated by the base user interface 112 at a given time detailing the width X₁ and height Y₁ of the base user interface element 410 (as measured in pixels), as well as the width X₂ and height Y₂ of the base user interface itself 112 (as also measured in pixels).

The user interface interpreter submodule 625 in the embodiment shown in FIG. 6, may also have access to data including but not limited to data regarding the coordinates, shape, color, resolution and any other characteristics of appearance of the base video display within which the base user interface appears. For example, with respect to the embodiment described in FIG. 4, the user interface interpreter submodule may have access to data detailing the width X₃ and height Y₃ of the base video display 110 (as measured in physical length, such as inches, centimeters, or any other known and established standard measure of physical distance), as well as the resolution (number of pixels per square unit of area) of the user interface 112 as displayed by the base video display 110. The user interface interpreter submodule in this embodiment may use this measurement data to correlate the number of pixels shown in the base user interface 112 with a unit of physical length of the base video display 110. In other words, the user interface interpreter submodule in this embodiment may calculate the physical length X₁ and height Y₁ of a base user interface element 410, as displayed on the base user interface 112, and the physical length X₂ and height Y₂ of the base user interface 112 itself. The user interface interpreter submodule may use this measurement data to calculate the physical distance between the top and bottom edges of the base user interface 112 and the top and bottom edges of the base video display 110, as well as the physical distance between the left and right edges of the base user interface 112 and the left and right edges of the base video display 110. Thus, the user interface interpreter submodule in this embodiment may determine the location of a base user interface element 410 with respect to the borders of the base video display 110, as displayed by the user interface 112.

The three-dimensional mapping submodule 630 shown in FIG. 6, in an embodiment, may access data, including but not limited to the dimensions of the base video display. The three-dimensional mapping submodule 630 as shown in FIG. 6, in an embodiment, may further access data, including but not limited to data related to three-dimensional image taken by the three-dimensional camera array, and information regarding physical dimensions, colors, shading, and brightness of the base user interface and/or base user interface element displayed within the base user interface. The three-dimensional mapping submodule 630 in an embodiment may further access data including but not limited to data calculated or determined by the user interface interpreter submodule 625, including: (1) the identification of the base user interface element as identified within the base user interface by the user interface interpreter submodule 625; (2) characteristics such as position and orientation of base user interface element displayed with respect to the base user interface, that can be used to determine the location of the base user interface element within the borders of the base user interface; and (3) the orientation of the plane of the base user interface and base video display with respect to the head mounted display device, and as further described herein.

The error adaptation submodule 630 as shown in FIG. 6, in an embodiment, may be capable of accessing the three-dimensional map generated by the three-dimensional mapping submodule 630. The low-level graphics primitives submodule 635 shown in FIG. 6, in an embodiment, may be capable of accessing data including, but not limited to input from the user regarding the user's preferred orientation of merged head mounted display user interface elements with respect to the base video display. For example, the low-level graphics primitives submodule 645 may access input from the user regarding whether the user wishes to view the merged head mounted display device user interface elements only outside the borders of the base video display. The low-level graphics submodule 645 shown in FIG. 6, in an embodiment, may be capable of accessing data including, but not limited to the three-dimensional map generated by the three-dimensional mapping submodule 630. The remote rendering a load submodule 650 may be capable of accessing data including, but not limited to the three-dimensional map generated by the three-dimensional mapping submodule 630 and the graphics primitives generated by the low-level graphics primitives submodule 645. The customized low level graphics primitives submodule 655 may be capable of accessing data including, but not limited to the customized merged head mounted display device user interface element definition received by the merger customization submodule 615, and the three-dimensional map generated by the three-dimensional mapping submodule 630. The customized remote rendering and load submodule 660 may be capable of accessing data including, but not limited to the three-dimensional map generated by the three-dimensional mapping submodule 630, and the customized low-level graphics primitives generated by the customized low-level graphics primitives submodule 655.

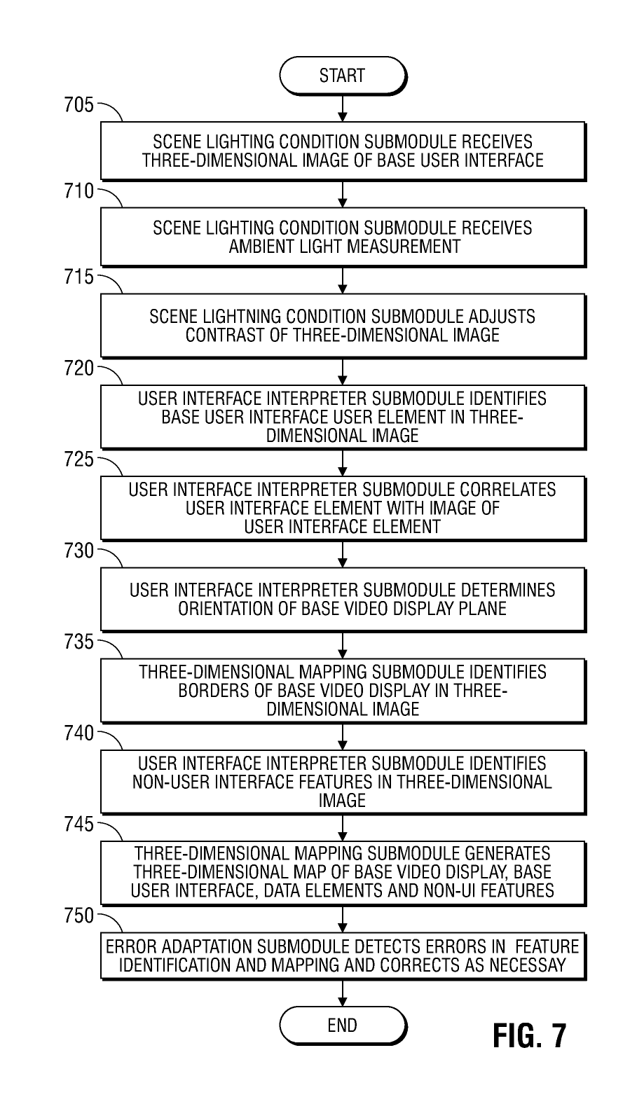

FIG. 7 is a flow diagram illustrating method of operating a multiple device augmented surface management system according to an embodiment of the present disclosure. In a particular embodiment, the method may include one or more of identifying a base user interface, a base user interface element, the borders of a base video display, and non-base user interface features, mapping the borders and orientation of the base video display with respect to the head mounted display device, and correlating base user interface elements displayed by the base user interface with the image of those base user interface elements displayed by the base user interface as captured in a three-dimensional image, and generating a three-dimensional map of the base user interface, the base user interface elements, base video display, and non-base user interface features. At block 705, in an embodiment, the scene lighting condition submodule may receive the three-dimensional image of the base user interface, base user interface element, base video display, and non-base user interface feature, as captured by the three-dimensional camera array mounted to the head mounted display device. In this scenario, the user wearing the head mounted display device may be looking at, and thus, pointing the head mounted display device and its three-dimensional camera array toward the non-base user interface feature, and the base video display, which displays the base user interface, and base user interface element. Thus, in an embodiment, when the three-dimensional camera array captures a three-dimensional image, that three-dimensional image may include an image of the base user interface, base user interface element, base video display, and non-base user interface feature. For example, in the embodiment depicted in FIG. 5, the three-dimensional image 500 may include an image of the base user interface 112, base user interface element 410, base video display 110, and non-base user interface feature 210.

At block 710, in an embodiment, the scene lighting condition submodule may receive data regarding ambient light surrounding the head mounted display device, as measured by the ambient light detector. As described herein, the ambient light detector may measure the ambient light surrounding the head mounted display device in an embodiment using any type of electro-optical sensor capable of detecting ambient light surrounding the head mounted display device and converting the ambient light measurement into an electronic signal, including but not limited to photoconductive devices, photovoltaics, photodiodes, or phototransistors.

At block 715, in an embodiment, the scene lighting condition submodule may adjust the contrast of the three-dimensional image based on the ambient light measurement. The scene lighting condition submodule in an embodiment may adjust the three-dimensional image of the base user interface, base user interface element, base video display, and non-base user interface feature as captured by the three-dimensional camera array based on the ambient light measured by the ambient light detector through any one of several known methods for adjusting contrast of digital images, including but not limited to raster graphics editing and vector graphics editing. It is contemplated that many methods for adjusting contrast of digital images to account for ambient light are known in the field of digital imaging.

At block 720, in an embodiment, the user interface interpreter submodule may identify a base user interface element in the three-dimensional image. As described herein, in an embodiment, the base video display may display a base user interface element as part of the base user interface, and the three-dimensional camera array on the head-mounted display device may capture a three-dimensional image of the base video display, the base user interface, the base user interface element, and the non-base user interface feature. For example, in the embodiment shown in FIG. 4, the base video display 110 may display a base user interface element 410 as part of the base user interface 112. As a further example, in the embodiment shown in FIG. 5, the three-dimensional image 500 may include an image of the base video display 110, the base user interface 112, the base user interface element 410, and the non-base user interface feature 210.

As described herein, in an embodiment, the user interface interpreter submodule may be capable of accessing data including but not limited to data generated by the base user interface regarding the coordinates, shape, color, and any other characteristics of the base video display, appearance of each base user interface element as displayed on the user interface at any given time. In one embodiment, the user interface interpreter submodule may use this information regarding physical dimensions, colors, shading, and brightness of the base user interface and/or base user interface element displayed within the base user interface, along with an image matching algorithm to identify any base user interface elements represented by the base user interface and displayed on the base video display, that are captured in the three-dimensional image. For example, in the embodiment described with reference to FIG. 5, the user interface interpreter submodule may use this information along with an image matching algorithm to identify base user interface element 410 within the three-dimensional image 500.

It is contemplated that the user interface interpreter submodule may use object recognition methods, including but not limited to approaches based on computer aided design like object models, appearance-based methods, and feature-based methods. Approaches based on computer aided design like object models may further include, but may not be limited to edge detection, primal sketch, Marr, Mohan and Nevatia's approach, Lowe's Approach, Olivier Faugeras' approach, generalized cylinders, geons, and Dickinson, Forsyth and Ponce's approach. Appearance-based methods may further include, but may not be limited to edge matching, divide and conquer search, greyscale matching, gradient matching, histograms of receptive field responses, and large modelbases. Feature-based methods may further include, but may not be limited to interpretation trees, hypothesize and test methods, pose consistency, pose clustering, invariance, geometric hashing, scale-invariant feature transform, and speeded up robust features.

At block 725, in an embodiment, the user interface interpreter submodule may further correlate the base user interface element as displayed on the base video display with the image of the base user interface element as captured in the three-dimensional image. In other words, the user interface interpreter submodule may associate the base user interface element displayed within the base user interface, with the image of the base user interface element captured in the three-dimensional image, such that other modules, instructions, or processes may interpret actions taken to manipulate either the base user interface element as displayed within the base user interface, or the image of the base user interface element as shown in the three-dimensional image to affect manipulation of both the base user interface element as displayed within the base user interface, and the image of the base user interface element as shown in the three-dimensional image. For example, in the embodiments described in FIGS. 4 and 5, the user interface interpreter submodule may associate the base user interface element 410 displayed within the base user interface 112, as shown in FIG. 4, with the image of the base user interface element 410 captured in the three-dimensional image 500 by the three-dimensional camera array 310, as shown in FIG. 5, such that other modules, instructions, or processes may interpret actions taken to manipulate either the base user interface element 410 as displayed within the base user interface 112 and as shown in FIG. 4, or the image of the base user interface element 410 as shown in the three-dimensional image 500 of FIG. 5 to affect manipulation of both the base user interface element 410 as displayed within the base user interface 112 of FIG. 4, and the image of the base user interface element 410 as shown in the three-dimensional image 500 of FIG. 5.

At block 730, in an embodiment, the user interface interpreter submodule may also determine the orientation of the plane of the base video display with respect to the head mounted display device. As described herein, the user interface interpreter submodule in an embodiment may access data regarding the dimensions of the base video display, the characteristics of the base user interface and/or base user interface element. For example, in an embodiment, the user interface interpreter submodule may access characteristics including, but not limited to information regarding physical dimensions, colors, shading, and brightness of the base user interface and/or base user interface element. The user interface interpreter submodule in an embodiment may compare these characteristics of the base user interface and/or base user interface element as displayed on the base video display to the characteristics of the base user interface and/or base user interface element as captured in the three-dimensional image. In an embodiment, the comparison between these characteristics as displayed on the base video display and as captured in the three-dimensional image, may be analyzed using an image processing method to determine the plane of the base video display with respect to the three-dimensional camera array and the head-mounted display device at the time of the capture of the three-dimensional image. It is contemplated any image processing method known in the art to be capable of attitude determination of features within an image could be used in an embodiment.

At block 735, in an embodiment, the three-dimensional mapping submodule may identify the borders of the base video display in the three-dimensional image. In an embodiment, the three-dimensional mapping submodule may identify the borders of the base video display 110 as shown in the three-dimensional image. As described herein, the three-dimensional mapping submodule, in an embodiment, may access data including but not limited to data related to three-dimensional image taken by the three-dimensional camera array, and identification of the base video display within that image as made by the user interface interpreter submodule. Also as described herein, in an embodiment, the user interface interpreter submodule may calculate the physical length and height of a base user interface element, as displayed on the base user interface, and the physical length and height of the base user interface itself. For example, in an embodiment as depicted in FIG. 4, the user interface interpreter submodule may calculate the physical length X₁ and height Y₁ of a base user interface element 410, as displayed on the base user interface 112, and the physical length X₂ and height Y₂ of the base user interface 112 itself.

The user interface interpreter submodule in an embodiment may use calculations of the physical dimensions of the base user interface element as displayed on the base user interface and the physical dimensions of the base user interface itself to determine the location of a base user interface element with respect to the borders of the base video display. In other words, the user interface interpreter submodule in an embodiment may calculate the orientation of a base user interface element with respect to the borders of the base video display (in physical dimensions). As described herein, the location of the base user interface element with respect to the borders of the base video display, as calculated by the user interface interpreter submodule, does not necessarily take into account the change in orientation of the plane of the base video display as captured in the three-dimensional image from the perspective of the head-mounted display device. For example, in the embodiments described with respect to FIGS. 4 and 5, the location of the base user interface element 410 with respect to the borders of the base video display 110 as shown in FIG. 4 and calculated by the user interface interpreter submodule may not take into account the change in orientation of the plane of the base video display 110 as captured in the three-dimensional image 500 from the perspective of the head-mounted display device 130, as shown in FIG. 5.

As described herein, the head mounted display device, and thus the three-dimensional camera array in an embodiment may view the base user interface within the base video display at an angle other than perfectly perpendicular from and/or directly above the base user interface. As described herein, the head mounted display device in an embodiment may perceive the top of the base user interface as farther away from the head mounted display device than the bottom of the base user interface, particularly if a user tilts the base video display. If the user tilts the device in such a way, the dimensions of the base user interface elements as viewed by the head mounted display device appear skewed when compared to the dimensions of the base user interface elements as displayed by the base user interface. As described herein, the three-dimensional mapping submodule may access data regarding the orientation of a base user interface element with respect to the borders of the base video display (in physical dimensions), as calculated by the user interface interpreter submodule.

For example, in the embodiment described with respect to FIG. 5, the head mounted display device 130 in an embodiment may perceive the top of the base user interface 112 as farther away from the head mounted display device 130 than the bottom of the base user interface 112, particularly if a user tilts the base video display 110. In this scenario, if the user tilts the device in such a way, the dimensions of the base user interface elements 410 as viewed by the head mounted display device appear skewed when compared to the dimensions of the base user interface elements 410 as displayed by the base user interface 112. For example, although the display of the base user interface 112 in an embodiment does not change between FIGS. 4 and 5, the measurement of the width X₁ of the base user interface element 410 in FIG. 4 is not equivalent to the measurement of the width X₄ of the same base user interface element 410 in FIG. 5. This skewed appearance in an embodiment is the result of a difference in orientation of the plane of the base video display 110 and base user interface 112 between FIGS. 4 and 5.

At block 735, the three-dimensional mapping submodule in an embodiment may identify the borders of the base video display in the three-dimensional image by projecting the orientation of the base user interface element with respect to the borders of the base video display (in physical dimensions) in a flat plane onto the actual plane as captured in the three-dimensional image using the orientation of the plane of the base video display, as calculated in FIG. 7 at block 730. This projection may allow the three-dimensional mapping submodule in an embodiment to estimate where the borders of the base video display should lie in the three-dimensional image based on the location and orientation of the base user interface element as captured in the three-dimensional image and as identified by the user interface interpreter submodule in FIG. 7 at block 720.

At block 740, in an embodiment, the user interface interpreter submodule may identify a non-base user interface feature in the three-dimensional image. In an embodiment, the user interface interpreter submodule may identify features within the three-dimensional image other than the base video display, base user interface, or base user interface element as a non-base user interface feature. For example, in the embodiment described in FIG. 5, the user's hand is visible in the three-dimensional image 500. In this embodiment, the user interface interpreter submodule may identify the user's hand as shown in the three-dimensional image 500 as a non-base user interface feature 210. This is only one example of a non-base user interface feature, which may include, but not be limited to any object detected in the three-dimensional image other than the base video display, the base user interface, the base user interface element, or an input device.

At block 745, in an embodiment, the three-dimensional mapping submodule may generate a three-dimensional map of the base video display, the base user interface, the base user interface element, and/or any non-base user interface feature captured in the three-dimensional image. As described herein, the three-dimensional mapping submodule, in an embodiment, may access data including but not limited to data related to three-dimensional image taken by the three-dimensional camera array. In an embodiment, at block 745, the three-dimensional mapping submodule may use the three-dimensional image, as adjusted by the scene lighting condition submodule to calculate or determine the physical coordinates of any object (or pixel) captured in the three-dimensional image. The three-dimensional mapping submodule in an embodiment may also access data regarding any identification of the edges of the base video display (as identified by the three-dimensional mapping submodule in FIG. 7 at block 735), the base user interface element (as identified by the user interface interpreter submodule in FIG. 7 at block 740), and/or the non-base user interface feature (as identified by the user interface interpreter submodule in FIG. 7 at block 740). The three-dimensional mapping submodule, in an embodiment, may associate or correlate the identification of the objects or features within the three-dimensional image with the measurements of the physical location of each of these identified objects as recorded or calculated within the three-dimensional image. The three-dimensional mapping submodule in an embodiment may further generate a low-level graphics primitive of the base video display having the coordinates of the base video display as measured or calculated within the three-dimensional image. For example, in the embodiment described with respect to FIG. 5, the three-dimensional mapping submodule may associate or correlate the identification of the base video display 110 within the three-dimensional image 500 with the measurements of the physical location of the base video display 110 with respect to the head mounted display device, as recorded or calculated within the three-dimensional image 500. The three-dimensional mapping submodule in this example embodiment may further generate a low-level graphics primitive of the base video display 110 having the coordinates as calculated within the three-dimensional image 500.

At block 750, in an embodiment, the error adaptation submodule may detect errors in feature identification and mapping and correct those errors as necessary. In an embodiment, an error adaptation submodule may access the three-dimensional map generated by the three-dimensional mapping submodule. The error adaptation submodule may detect errors in feature identification and mapping of those features in an embodiment through any means of observational error or measurement error correction. For example, in an embodiment, an error adaptation submodule may compare identification or mapping of the same feature in several three-dimensional maps captured over a period of time, and detect a statistical deviation in one of the identifications or mappings. In such a scenario, the error adaptation submodule may correct this deviation by adapting that identification or mapping to fall more in line with the identifications or mappings captured both before and after the erroneous identification or mapping. It is contemplated any method to correct the multiple testing problem of statistics may be used, including, but not limited to multiple testing correction, the Bonferroni method, the closed testing procedure, the Boole-Bonferroni bound, and the Holm-Bonferroni method.

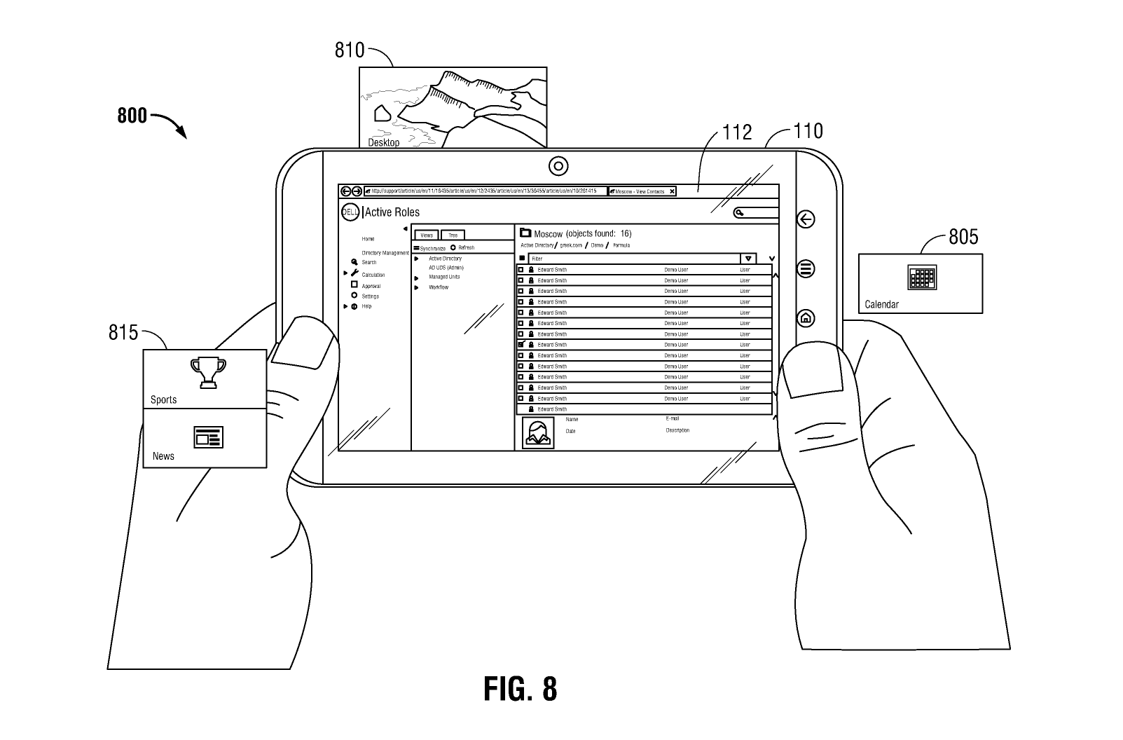

FIG. 8 is a depiction of a first view of the operation of a multiple device augmented surface management system according to an embodiment of the present disclosure. As shown in FIG. 8, in an embodiment, a first view of a head mounted display device user interface 800 may include multiple two-dimensional merged head mounted display device user interface elements 805, 810, and 815 displayed only outside the borders of the base video display 110, so as not to obscure any portion of the view of the base video display 110 or, in another aspect, any portion of base user interface 112 displayed on base video display 110. The two-dimensional merged head mounted display device user interface element 805 shown in FIG. 8 is a navigation tile for the calculator application, the two-dimensional merged head mounted display device user interface element 810 is a navigation tile for the desktop, and the two-dimensional merged head mounted display device user interface element 815 is a navigation tile for the sports application. However, the merged head mounted display device user interface elements in an embodiment could be any type of object, button, tile, icon, program window, or other visual representation from a computer program or software that facilitates interaction between the user and the processor. The merged head mounted display device user interface elements of an embodiment may be displayed as two-dimensional objects, or as three-dimensional objects. Although FIG. 8 only depicts the two-dimensional merged head mounted display device user interface elements 805, 810, and 815 as displayed outside the borders of the base video display 110 or base user interface 112, the merged head mounted display device user interface elements 805, 810, and 815 may be displayed in any configuration with respect to one another and with respect to the base video display 110 or base user interface 112.

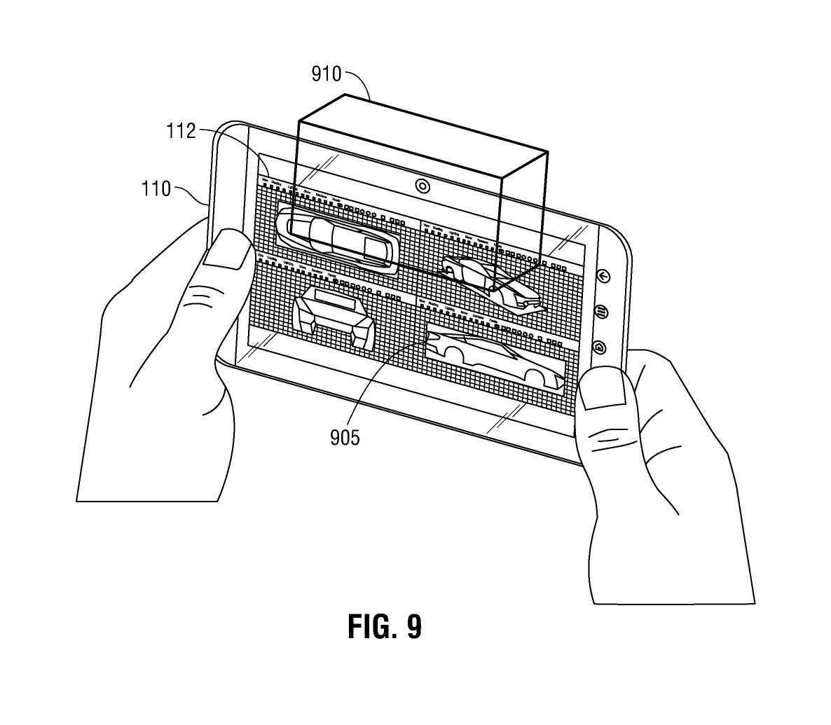

FIG. 9 is a depiction of a second view of the operation of a multiple device augmented surface management system according to another embodiment of the present disclosure. As shown in FIG. 9, in another aspect of an embodiment, a second view from a head mounted display device user interface 900 may include a three-dimensional merged head mounted display device user interface element 910 displayed, at least partially, within the borders of the base video display 110. For example, as shown in FIG. 9, in an aspect of an embodiment, a user may view a three-dimensional computer aided drafting program on the base user interface 112, which includes a three-dimension model of a structure 905. In this scenario, the head mounted display device user interface 900 may include the three-dimensional merged head mounted display device user interface element 910, which may be, for example, a three-dimensional representation of the three-dimensional model of the structure 905.

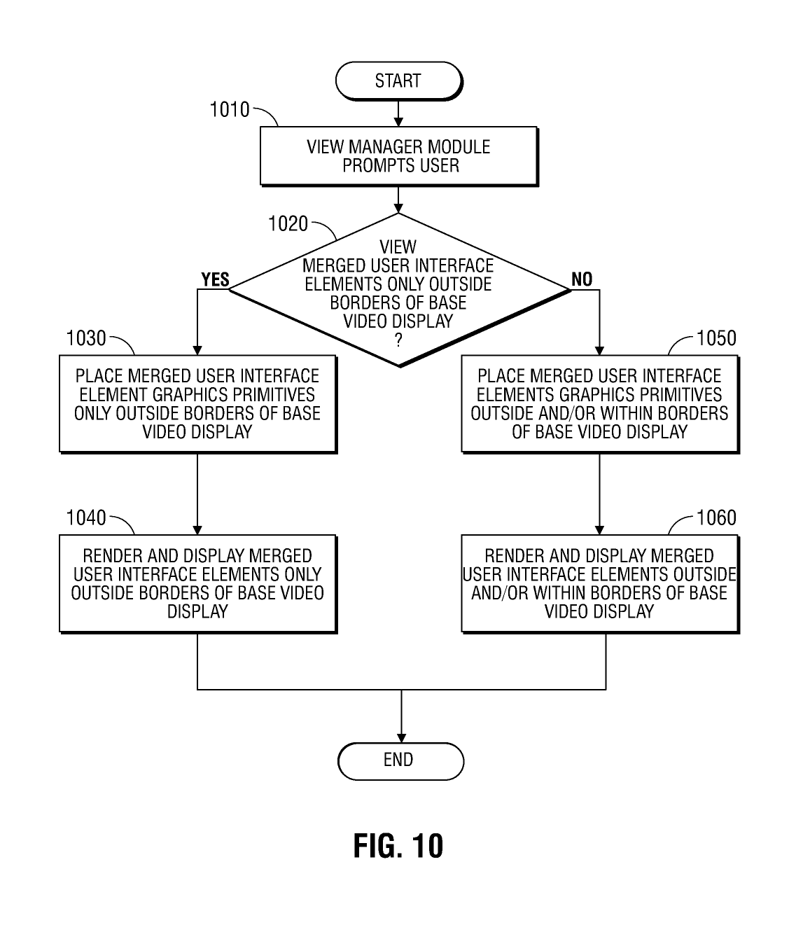

FIG. 10 is a flow diagram illustrating a method of a merged interface rendering with the multiple device augmented surface management system according to an embodiment of the present disclosure. At block 1010, in an embodiment, the view manager submodule may prompt the user for information regarding the format in which the user chooses to display merged head mounted display device user interface elements. For example, in an embodiment, the view manager submodule may request the user choose whether to display merged head mounted display device user interface elements only outside the borders of the base video display. In an embodiment, at block 1020, the user may choose to view the merged head mounted display device user interface elements only outside the borders of the base video display in any number of ways, including, but not limited to, toggling a physical switch on the head-mounted display device or base video display, toggling a switch in the form of a base user interface element, a head mounted display device user interface element, or through audio command. If the user chooses to view the merged head mounted display device user interface elements only outside of the borders of the base video display in an embodiment, the merged interface rendering submodule would move to block 1030. If the user does not choose to view the merged head mounted display device user interface elements only outside of the borders of the base video display, the merged interface rendering submodule would move to block 1050.

In an embodiment, at block 1030, the low-level graphics primitive submodule may generate a merged head mounted display device user interface element primitive and place that primitive outside the base video display borders. It is understood low-level graphics primitives operate graphics rendering methods to provide a simple geometric form upon which more elaborate graphics such as surface textures, lighting, surface patterns, or surface images may be overlaid. Using primitives allows rendering techniques to streamline the movement and articulation of subcomponents of complex structures more efficiently. Low-level graphics primitives in an embodiment may include geometric forms including, but not limited to, points, lines, line segments, planes, circles, ellipses, triangles, polygons, spline curves, spheres, cubes, boxes, toroids, cylinders and pyramids. The low-level primitives submodule in an embodiment may generate a primitive having the size, shape, and location of a merged head mounted display device user interface element as it would appear after it is rendered and displayed. For example, with respect to the embodiment described in FIG. 8, for a merged head mounted display device user interface element 805 having a rectangular shape, the low-level primitives submodule may associate the merged head mounted display device user interface element 805 with a rectangular graphics primitive having a location outside the borders of the base video display 110.

At block 1040, in an embodiment, the remote rendering and load submodule may render the head mounted display device user interface element outside the base video display borders. In an embodiment, at block 1040, the remote rendering and load submodule may render the merged head mounted display device user interface element surface texture, lighting, surface pattern, or other surface image onto the graphics primitive for the merged head mounted display device user interface element, which may be located outside the borders of the base video display. For example, with respect to the embodiment described in FIG. 8, the remote rendering and load submodule may render the merged head mounted display device user interface element 805 surface texture, lighting, surface pattern, or other surface image onto the rectangular graphics primitive for the merged head mounted display device user interface element 805, located outside the borders of the base video display 110.

In an embodiment, at block 1050, the low-level graphics primitives submodule may generate graphics primitive of a merged head mounted display device user interface element and place that primitive within and/or outside the base video display borders. At block 1050, the low-level graphics primitives submodule in an embodiment may generate a graphics primitive having the size, shape, and location of the merged head mounted display device user interface element as it would appear after it is rendered and displayed. For example, with reference to the embodiment described in FIG. 9, for a merged head mounted display device user interface element 905 having a three-dimensional shape that includes a cube attached to a cylinder, the low-level graphics primitives submodule may associate the merged head mounted display device user interface element 905 with a cubic and cylindrical graphics primitive having a location both within and outside the borders of the base video display 110.

At block 1060, in an embodiment, the remote rendering and load submodule may render and display a merged head mounted display device user interface element within and/or outside the base video display borders. In an embodiment, at block 1040, the remote rendering and load submodule may render the surface texture, lighting, surface pattern, or other surface image onto the graphics primitive for the merged head mounted display device user interface element, which may be located within and/or outside the borders of the base video display. For example, with reference to the embodiment described in FIG. 9, the remote rendering and load submodule may render the surface texture, lighting, surface pattern, or other surface image of the merged head mounted display device user interface element 905 onto the cubic and cylindrical graphics primitives having location within and/or outside the borders of the base video display 110.

As described herein, the user interface interpreter submodule may associate the base user interface element displayed within the base user interface, with the image of the base user interface element captured in the three-dimensional image, such that other modules, instructions, or processes may interpret actions taken to manipulate either the base user interface element as displayed within the base user interface, or the image of the base user interface element as shown in the three-dimensional image to affect manipulation of both the base user interface element as displayed within the base user interface, and the image of the base user interface element as shown in the three-dimensional image. As further described herein, the multiple device augmented surface management system, which controls the display of merged head mounted display device user interface elements may connect to a bus of the information handling system in order to communicate with the information handling system and any subcomponents of the information handling system, including the base user interface, which controls the display of base user interface elements. As also described herein, the information handling system of an embodiment may receive user input via an input device, directing the manipulation of a base user interface element, or a merged head mounted display device user interface element. For example, with reference to the embodiment described in FIG. 1, the multiple device augmented surface management system 132 may connect to the bus 108 of information handling system 100, and thus, may be in communication with the base user interface 112. Also with reference to the embodiment described in FIG. 1, the information handling system 100 may receive user input via input device 118, directing the manipulation of a base user interface element, or a merged head mounted display device user interface element.

As described herein, the information handling system of an embodiment may be in communication with the multiple device augmented surface management system and any of its submodules. Further, in an embodiment, the information handling system may also have access to data generated by any of the multiple device augmented surface management submodules. For example, with reference to the embodiment described in FIG. 6, the information handling system (not shown), may connect to the network 128, or to the network interface device 120, both of which may also connect to the multiple device augmented surface management system 132. As a further example, in the embodiment described in FIG. 6, the information handling system (not shown), may be in communication with each of the submodules of the multiple device augmented surface management system 132, including, but not limited to, the user interface interpreter submodule 625.

Thus, the information handling system in an embodiment may have access to any correlation the user interface interpreter submodule may make between a base user interface element and an image of the same base user interface element as captured in a three-dimensional image. For example, with reference to the embodiment described in FIG. 7, the user interface interpreter submodule, at block 725 may correlate a base user interface element with an image of the same base user interface element.

In addition, the information handling system in an embodiment may have access to any merged head mounted display device user interface elements the remote rendering and load submodule may render and display. For example, with reference to the embodiment described in FIG. 10, the remote rendering and load submodule, at block 1040, may render and display merged head mounted display device user interface elements only outside the borders of the base video display, or, at block 1060, may render and display merged head mounted display device user interface elements outside and/or within the borders of the base video display. As another example, with reference to the embodiment described in FIG. 9, the remote rendering and load module (not shown) may display the merged head mounted display device user interface element 910 within the borders of the base video display 110 which is simultaneously displaying a base user interface element 905 representing the same three-dimensional object as that depicted in the merged head mounted display device user interface element 910.

Thus, the information handling system in an embodiment may be able to receive input from a user input device, instructing manipulation of either a base user interface element, a merged head mounted display device user interface element, or both simultaneously. Because the information handling system in an embodiment may be in communication with the base user interface and the submodules directing rendering of the merged head mounted display device user interface elements, the information handling system in an embodiment could instruct base user interface to manipulate base user interface elements accordingly, instruct the remote rendering and load submodule to manipulate merged head mounted display device user interface elements, or could instruct both the base user interface and the remote rendering and load submodule to manipulate the base user interface elements and merged head mounted display device user interface elements simultaneously.

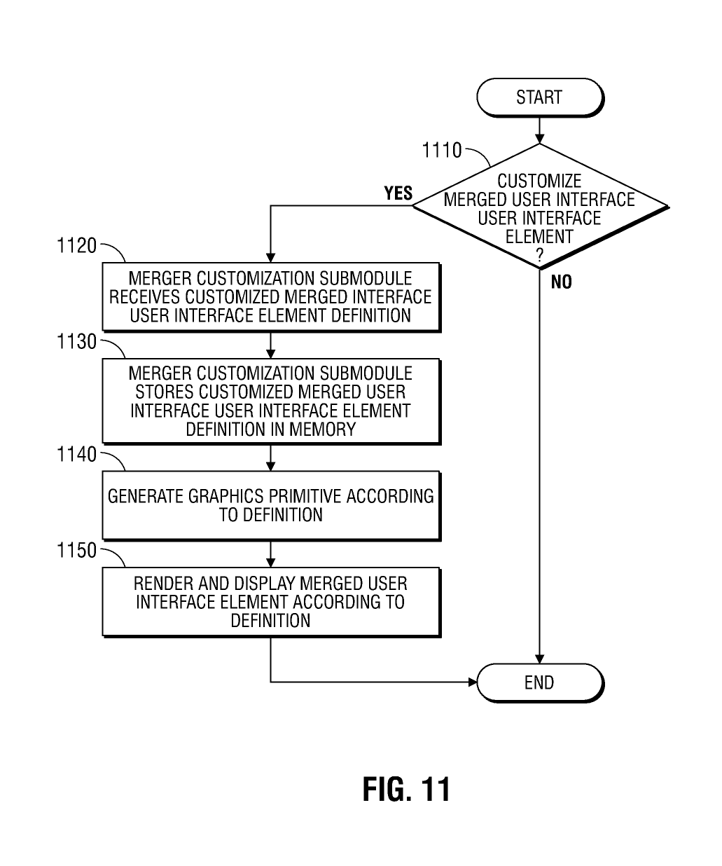

FIG. 11 is a flow diagram illustrating a method of merger customization with the multiple device augmented surface management system according to the customized merged user interface definition according to an embodiment of the present disclosure. As shown in FIG. 11, at block 1110 in an embodiment, the user may choose to customize a merged head mounted display device user interface element. Customization of a merged head mounted display device user interface element may include specifying the size or location of the merged head mounted display device user interface element with reference to other merged head mounted display device user interface elements, or with reference to the base video display. Customization may also include specifying whether to view the merged head mounted display device user interface element as a two-dimensional object or a three-dimensional object. Customization may also include specifying viewing of a merged head mounted display device user interface element only while viewing a specific application on the base video display, or only while not viewing a specific application on the base video display. These customizations are only a few examples of a wide range of potential customizations, which can include any specification as to the orientation of merged head mounted display device user interface elements within the merged user interface, and correlation between the display of merged head mounted display device user interface elements with base user interface elements. Each of the customizations may also be triggered depending on the context of software applications operating on the base information handling system. For example, certain software applications may cause augmentation of merged head mounted display device user interface elements of a head-mounted display device to be displayed outside the base information handling system display or graphical user interface in some embodiments. In other embodiments, customization due to operating software applications may cause some or all head-mounted display device images to be fully merged or partially merged with the base device display or user interface. In yet other aspects, where location of head-mounted display images or base user interface elements or to what extent they are integrated and overlapped with display from the base video display user interface may be specified depending on the context of software applications operating on the base user information handling system as may be appreciated.

For example, with respect to the embodiment described in FIG. 8, if a user chooses to display the merged head mounted display device user interface element 805 only outside the borders of the base video display 110, the user could also choose to customize the merged head mounted display device user interface element 805 by displaying the merged head mounted display device user interface element 805 only on the right side of the base video display 110. This is only one example of a potential customization of a merged head mounted display device user interface element. Other potential customizations could include but are not limited to, display of base user interface elements in two-dimensions, display of base user interface elements in three-dimensions, display of base user interface elements on any one specific side of the base video display borders, or any combination of specific sides of base video display borders, display of merged head mounted display device user interface elements only during use of certain applications on base user interface, or no display of certain merged head mounted display device user interface elements during use of certain applications on base user interface. In one aspect, the merger customization submodule may detect one or more software applications operating on either the base information handling system or the head-mounted information handling system. In an embodiment, the merger customization submodule may then cross-reference which software applications are operating with customization definition profiles associated with those software applications. In another example embodiment, customization definition profiles may be determined by matching to detected environment factors of the base information handling system or head-mounted display including location (such as in an work location, home location, or other), detected orientation movement of the base information handling system, ambient lighting conditions, or other detected contextual inputs.

At block 1120, in an embodiment, if the user chooses to customize the merged head mounted display device user interface element, the merger customization submodule may receive a customized merged head mounted display device user interface element definition. The customized merged head mounted display device user interface element definition of a customization definition profile may consist of a program instruction detailing the chosen customization. For example, with respect to the embodiment described in FIG. 8, the merger customization submodule may receive a customized merged head mounted display device user interface element definition indicating the merged head mounted display device user interface element 805 may only be displayed on the right side of the base video display 110.

At block 1130, in an embodiment, the merger customization submodule may store the customized merged head mounted display device user interface element definition in memory. In an embodiment, the merger customization submodule may store the customized merged head mounted display device user interface element interface in any memory to which it has access, including, but not limited to main memory, static memory, or the disk drive unit.

At block 1140, in an embodiment, the customized low-level graphics primitives submodule may generate a merged head mounted display device user interface element graphics primitive according to the customized merged head mounted display device user interface element definition. For example, in an embodiment where customization of a merged head mounted display device user interface element includes specifying the size or location of the merged head mounted display device user interface element with reference to other merged head mounted display device user interface elements, or with reference to the base video display, the low-level graphics primitives submodule may generate a merged head mounted display device user interface element graphics primitive having the specified size or location given in the customized merged head mounted display device user interface element definition. In another example, in an embodiment where customization includes specifying whether to view the merged head mounted display device user interface element as a two-dimensional object or a three-dimensional object, the customized low-level graphics primitives submodule may generate a two-dimensional or three-dimensional merged head mounted display device user interface element graphics primitive, depending upon the specified dimensionality given in the customized merged head mounted display device user interface element definition. In another example, in an embodiment where customization includes specifying viewing of a merged head mounted display device user interface element only while viewing a specific application on the base video display, or only while not viewing a specific application on the base video display, the customized low-level graphics primitives submodule may only display the merged head mounted display device user interface element only while the base user interface simultaneously displays a specified base user interface element, or the customized low-level graphics primitives submodule may only display the merged head mounted display device user interface element only while the base user interface simultaneously does not display a specified base user interface element, depending on the specified correlation between the display of merged head mounted display device user interface elements with base user interface elements given in the customized merged head mounted display device user interface element definition. These customizations are only a few examples of a wide range of potential customizations, which can include any specification as to the orientation of merged head mounted display device user interface elements within the merged user interface, and correlation between the display of merged head mounted display device user interface elements with base user interface elements.

At block 1150, in an embodiment, the customized remote rendering and load submodule may render and display a merged head mounted display device user interface element according to the customized merged head mounted display device user interface element definition. For example, in an embodiment where customization of a merged head mounted display device user interface element includes specifying the size or location of the merged head mounted display device user interface element with reference to other merged head mounted display device user interface elements, or with reference to the base video display, the customized remote rendering and load submodule may render and display a merged head mounted display device user interface element having the specified size or location given in the customized merged head mounted display device user interface element definition. In another example, in an embodiment where customization includes specifying whether to view the merged head mounted display device user interface element as a two-dimensional object or a three-dimensional object, the customized remote rendering and load submodule may render and display a two-dimensional or three-dimensional merged head mounted display device user interface element graphics primitive, depending upon the specified dimensionality given in the customized merged head mounted display device user interface element definition. In another example, in an embodiment where customization includes specifying viewing of a merged head mounted display device user interface element only while viewing a specific application on the base video display, or only while not viewing a specific application on the base video display, the customized remote rendering and load submodule may render and display a merged head mounted display device user interface element only while the base user interface simultaneously displays a specified base user interface element, or the customized remote rendering and load submodule may render and display a merged head mounted display device user interface element only while the base user interface simultaneously does not display a specified base user interface element, depending on the specified correlation between the display of merged head mounted display device user interface elements with base user interface elements given in the customized merged head mounted display device user interface element definition. For example, in the embodiment described in FIG. 9, the customized remote rendering and load submodule may render and display a merged head mounted display device user interface element 910 only when the base user interface 112 simultaneously displays a computer-aided drafting program that includes the base user interface element 905, depending on the specified correlation between the display of the merged head mounted display device user interface element 910 with the base user interface element 905 given in a customized merged head mounted display device user interface element definition.

These customizations are only a few examples of a wide range of potential customizations, which can include any specification as to the orientation of merged head mounted display device user interface elements within the merged user interface, and correlation between the display of merged head mounted display device user interface elements with base user interface elements.

The blocks of the flow diagrams discussed above need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

1. An information handling system operating as a head mounted computing device comprising:
a head mounted computing device having a three-dimensional camera to capture a three-dimensional image of a base computing device;
a head mounted computing device processor executing code instructions of a multiple device augmented surface management system to determine the edges of the base computing device as captured in the three-dimensional image of the base computing device;
receiving data indicating a displayed base user interface element from the base computing device;
the multiple device augmented surface management system to determine the angle of the base computing device digital display with respect to the head mounted computing device, to correlate a portion of a head mounted digital image with the three-dimensional image of the portion of the base computing device digital display, and to display the portion of the head mounted digital image in a preset position or orientation with respect to the displayed base user interface element.

2. The information handling system operating as a head mounted display device of claim 1, further comprising the head mounted computing device processor executing code instructions of the multiple device augmented surface management system to display the head mounted digital image such that a user may simultaneously interact with the head mounted digital image and the displayed base user interface element from the base computing device.

3. The information handling system of claim 1, wherein the head mounted digital image is correlated such that the head mounted digital image is displayed outside the edges of the base computing device.

4. The information handling system of claim 1, wherein the head mounted digital image is displayed such that the head mounted digital image is interactively coordinated with the displayed base user interface elements from the base computing device such that interaction with the base user interface alters the head mounted digital image.

5. The information handling system of claim 4, wherein a user input device is used to interact with either the displayed base user interface elements from the base computing device or the head mounted digital image.

6. The information handling system of claim 1, wherein a customized interface definition determines the preset position or orientation with respect to the displayed base user interface element based on the software determined to be operating on the base computing device.

7. The information handling system of claim 1, wherein the head mounted digital image is displayed to appear coplanar with the display of the base computing device.

8. A method for displaying a multi-device augmented surface comprising:
receiving a three-dimensional image of a base computing device captured via a head mounted computing device having a three-dimensional camera;
determining, via a processor executing code instructions of a multiple device augmented surface management system, the edges of the base computing device as captured in the three-dimensional image of the base computing device;
receiving data indicating displayed base user interface elements from the base computing device;
determining the angle of the base computing device planar digital display with respect to the head mounted computing device;
correlating a portion of the base computing device planar digital display with the image of the portion of the base computing device planar digital display as captured in the image of the base computing device; and
displaying the portion of the head mounted digital image in a preset position or orientation with respect to the displayed base user interface element.

9. The method for displaying a multi-device augmented surface of claim 8, further comprising:
executing code instructions of the multiple device augmented surface management system to display a head mounted digital image such that a user may simultaneously view the base user interface and the head mounted digital image.

10. The method for displaying a multi-device augmented surface of claim 8, wherein the head mounted digital image is correlated such that the head mounted digital image is displayed outside the edges of the base computing device.

11. The method for displaying a multi-device augmented surface of claim 8, wherein the head mounted digital image is displayed such that the head mounted digital image is interactively coordinated with the base user interface such that interaction with the base user interface alters the head mounted digital image.

12. The method for displaying a multi-device augmented surface of claim 11, wherein a user input device is used to interact with either the base user interface or the head mounted digital image.

13. The method for displaying a multi-device augmented surface of claim 8, wherein a customized interface definition determines the preset position or orientation with respect to the displayed base user interface element based on the software determined to be operating on the base computing device.

14. The method for displaying a multi-device augmented surface of claim 8, wherein the head mounted digital image is displayed to appear coplanar with the display of the base computing device.

15. An information handling system operating as a base computing device comprising:
a processor executing code instructions of a multiple device augmented surface management system to receive a three-dimensional image of the base computing device received from a three-dimensional camera attached to a head mounted display device;
the processor to determine the edges of the base computing device as captured in the three-dimensional image;
the multiple device augmented surface management system to determine the angle of the base computing device digital display with respect to the head mounted computing device, to correlate a portion of a head mounted digital image with the three-dimensional image of the base computing device digital display, and to display the portion of the head mounted digital image in a preset position or orientation with respect to the displayed base user interface element; and
the processor executing code instructions of the multiple device augmented surface management system to instruct a head mounted display device to display a head mounted digital image such that a user may simultaneously view the head mounted digital image and the displayed base user interface elements from the base computing device.

16. The information handling system of claim 15, wherein the processor instructs the head mounted digital image to be displayed such that the head mounted digital image is displayed outside the edges of the base computing device.

17. The information handling system of claim 15, wherein the processor instructs the head mounted digital image to be displayed such that the head mounted digital image is interactively coordinated with the displayed base user interface elements from the base computing device such that interaction with the base user interface alters the head mounted digital image.

18. The information handling system of claim 17, wherein a user input device is used to interact with either the displayed base user interface elements from the base computing device or the head mounted digital image.

19. The information handling system of claim 15, wherein a customized interface definition determines the preset position or orientation with respect to the displayed base user interface element based on the software determined to be operating on the base computing device.

20. The information handling system of claim 1, wherein the head mounted digital image is displayed to appear coplanar with the display of the base computing device.
